(19) United States
(12) Patent Application Publication
(10) Pub. No.: US 2016/0294447 A1
(43) Pub. Date: Oct. 6, 2016

(54) SYSTEM AND METHOD OF NEAR FIELD COMMUNICATION ENABLED DEVICE PROGRAMMING

(71) Applicant: Honeywell International Inc., Morristown, NJ (US)

(72) Inventors: Andrew G. Berezowski, Wallingford, CT (US); Vinayak Sadashiv Kore, Bangalore (IN); Jesse J. Otis, North Haven, CT (US)

(21) Appl. No.: 14/676,231

(22) Filed: Apr. 1, 2015

(51) Int. Cl. H04B 5/00; H04W 4/00

(52) U.S. Cl. CPC H04B 5/0037; H04W 4/008

(57) ABSTRACT

Systems and methods of near field communication enabled programming of peripheral devices in fire alarm and security systems are provided. For example, some systems can include a near field configuration device transmitting a near field communication signal to a peripheral device, and all or a portion of the peripheral device being powered for configuration via the near field communication signal.

### FIELD

The present invention relates generally to fire alarm and security system peripheral devices. More particularly, the present invention relates to a system and method of near field communication enabled programming of such peripheral devices.

### BACKGROUND

Peripheral devices in fire alarm and security systems must be configured. However, known configuration systems and methods require system power and a programming device or mechanical switch to configure the peripheral device. This is often undesirable.

In view of the above, there is a continuing, ongoing need for an improved system and method to configure or program peripheral devices.

### BRIEF DESCRIPTION OF THE DRAWINGS

FIG. 1 is a block diagram of a peripheral device in communication with a near field configuration device in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include a system and method of near field communication enabled programming of peripheral devices in fire alarm and security systems. In some embodiments, the systems and methods disclosed herein can securely configure and program a peripheral device without the need for system power or mechanical switches. Accordingly, the systems and methods disclosed herein can reduce cost and provide benefits that include, but are not limited to, fast configuration, automated configuration, increased access to information, downloaded software applications, and initial configuration of a device during production. For example, in some embodiments, a single peripheral device with a single SKU can be configured in one of a plurality of different ways without the need for a powered fixture.

In accordance with the systems and methods disclosed herein, in some embodiments, a peripheral device can be configured without removing the device from its packaging carton, a peripheral device can provide visual feedback of configuration information, a peripheral device can be configured without applying system power, all or a portion of a peripheral device can be powered using near field communication (NFC) technology, a memory device in a peripheral device can be used to store or read configuration data, and/or a microcontroller in a peripheral device can receive power to configure or read the device's memory.

In some embodiments, a peripheral device as disclosed herein can include at least a memory device, a microcontroller, and a near field communication interface. For example, the near field communication interface can harvest or receive energy or power for powering the device during device configuration or programming. That is, the peripheral device need not include or receive switches, system power, or battery power for device configuration or programming.

In some embodiments, a peripheral device as disclosed herein can include a display device, for example, an electronic paper display or other indicator that can display a static text, image, and/or color indefinitely without using electricity. In some embodiments, such a display device can be visible while the peripheral device is contained within its packaging carton and in some embodiments, the information on the display device can include configuration information and feedback.

In some embodiments of operation, a near field configuration device can be placed within a predetermined distance of a peripheral device as disclosed herein and can communicate with the peripheral device using near field communication technology. While in communication, the near field configuration device can provide power to the peripheral device, via the near field communication, for configuring the device. Accordingly, the near field configuration device can communicate with the peripheral device with or without opening the peripheral device's packaging carton and with or without applying system or battery power to the peripheral device.

In some embodiments, the near field configuration device can be used to perform any or all of the following exemplary configuration functions on the peripheral device, without limitation: setting the peripheral device address, assigning the peripheral device to a group or zone, assigning control of the peripheral device by event functions, assigning peripheral device output power levels, assigning peripheral device output functions, assigning peripheral device input functions, assigning peripheral device wiring configuration, and/or setting peripheral device detection thresholds and sensitivities.

In some embodiments, the near field configuration device can include any or all of the following exemplary software applications or programmed algorithms that can be executed during configuration of the peripheral device, without limitation: automatically incrementing the target device address, for example, the peripheral device address, when moving from one device to the next, and/or automatically assigning location information, zone information, or wireless mesh parent child relationships.

In some embodiments, the near field configuration device can receive or extract data from the peripheral device with which the configuration device is communicating. For example, extracted information can be used for diagnostic purposes or to perform real-time diagnostic testing on the peripheral device.

In some embodiments, one or both of the near field configuration device and the peripheral device can include a software application with a security feature for limiting access to the peripheral device to one or a particular group of configuration devices following initial configuration of the peripheral device. In some embodiments, the near field configuration device can contain a software application that enables the grouping of peripheral devices so that a group of peripheral devices can be mapped to one or more groups of system devices.

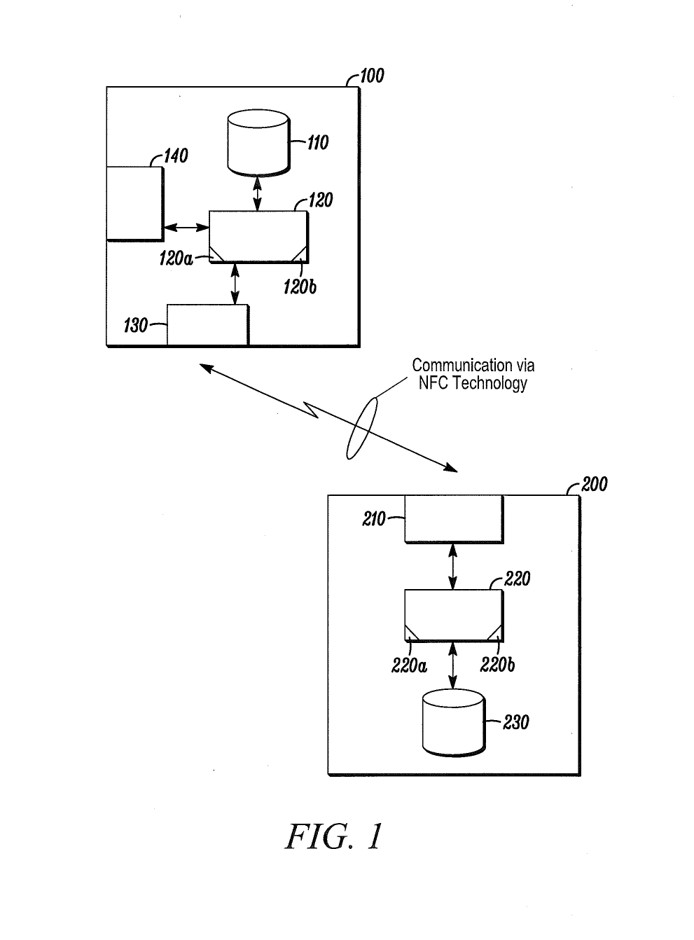

FIG. 1 is a block diagram of a peripheral device 100 in communication with a near field configuration device 200 in accordance with disclosed embodiments. As seen in FIG. 1, the peripheral device 100 can include at least a memory device 110, control circuitry 120, for example, a microcontroller, a near field communication interface 130, and, optionally, a display device 140, for example, an electronic paper display. However, it is to be understood that the peripheral device 100 can include other elements as known to be included in peripheral devices known in the art.

The control circuitry 120 can include one or more programmable processors 120a and executable control software 120b as would be understood by one of ordinary skill in the art. The executable control software 120b can be stored on a transitory or non-transitory computer readable medium, including, but not limited to, local computer memory, RAM, optical storage media, magnetic storage media, flash memory, and the like.

As seen in FIG. 1, the peripheral device 100 can communicate with the near field configuration device 200 via near field communication technology. The near field configuration device 200 can include at least a near field communication interface 210, control circuitry 220, for example, a microcontroller, and a memory device 230. The control circuitry 220 can include one or more programmable processors 220a and executable control software 220b as would be understood by one of ordinary skill in the art. The executable control software 220b can be stored on a transitory or non-transitory computer readable medium, including, but not limited to, local computer memory, RAM, optical storage media, magnetic storage media, flash memory, and the like.

In some embodiments, the executable control software 120b can include software applications or programmed algorithms that can be executed during communication with the near field configuration device 200, for example, when the peripheral device 100 is being powered via the near field communication with the configuration device 200. Similarly, in some embodiments, the executable control software 220b can include software applications or programmed algorithms that can be executed during communication with and configuration of the peripheral device 100. Furthermore, in some embodiments, the executable control software 220b can include software applications that can be transmitted or downloaded to the peripheral device 100 when the near field configuration device 200 is communicating with the peripheral device 100. In some embodiments, such software applications or programmed algorithms can include instructions on grouping devices.

When communicating via near field communication technology, the near field configuration device 200 can transmit a signal, via the communication interface 210, to the peripheral device 100, which can receive the signal, via the communication interface 130, and extract power therefrom. For example, upon receiving the signal from the near field configuration device 200, all or a portion of the peripheral device 100, for example, at least the control circuitry 120, can be powered by the signal and the contents thereof.

The signal received from the near field configuration device 200 can include configuration data, information, or instructions, and in some embodiments, the peripheral device 100 can store such configuration data, information, or instructions in the memory device 110. Furthermore, upon such receipt or storage, the display device 140 can display a predetermined indicator regarding the configuration status of the peripheral device 100.

In some embodiments, the peripheral device 100 can also transmit a signal, via the communication interface 130, to the near field configuration device 200 to provide the configuration device 200, via the communication interface 210, with diagnostic information regarding the peripheral device 100 and the configuration thereof. In some embodiments, the peripheral device 100 can transmit the signal with such information responsive to the near field configuration device 200 or a signal or instructions received therefrom.

In some embodiments, the executable control software 120b and/or the executable control software 220b can include a security feature as explained above.

Although a few embodiments have been described in detail above, other modifications are possible. For example, the logic flows described above do not require the particular order described, or sequential order, to achieve desirable results. Other steps may be provided, or steps may be eliminated, from the described flows, and other components may be added to, or removed from, the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

1. A system comprising:
a near field communication interface; and
control circuitry in communication with the near field communication interface,
wherein the near field communication interface receives a near field communication signal,
wherein the control circuitry is powered via power in the near field communication signal, and
wherein the control circuitry is configured via configuration data, information, or instructions in the near field communication signal.

2. The system of claim 1 further comprising a display device for displaying an indicator of configuration status.

3. The system of claim 2 wherein the display device includes an electronic paper display device.

4. The system of claim 1 wherein the control circuitry includes a microcontroller.

5. The system of claim 1 wherein the control circuitry includes a programmable processor and executable control software stored on a non-transitory computer readable medium, and wherein at least some of the executable control software is executed while the near field communication interface receives the near field communication signal.

6. The system of claim 1 further comprising a memory device, wherein the control circuitry stores configuration data, information, instructions, or software applications contained in the near field communication signal in the memory device.

7. The system of claim 1 wherein the control circuitry instructs the near field communication interface to transmit a second near field communication signal.

8. The system of claim 1 wherein, absent the near field communication interface receiving the near field communication signal, the control circuitry remains unpowered.

9. A system comprising:
a near field communication interface; and
control circuitry in communication with the near field communication interface,
wherein the control circuitry instructs the near field communication interface to transmit a near field communication signal to a displaced peripheral device, for configuration
wherein the near field communication signal includes power to power the displaced peripheral device, and
wherein the near field communication signal includes configuration data, information, or instructions to configure the displaced peripheral device.

10. The system of claim 9 wherein the near field communication signal includes power for powering at least control circuitry of the peripheral device.

11. The system of claim 10 wherein the control circuitry of the peripheral device includes a microcontroller.

12. The system of claim 10 wherein the control circuitry of the peripheral device includes a programmable processor and executable control software stored on a non-transitory computer readable medium, and wherein the near field communication signal includes power for powering execution of at least some of the executable control software.

13. The system of claim 9 wherein the near field communication signal includes data, information, or instructions for configuration of the peripheral device.

14. The system of claim 9 wherein the near field communication signal includes one or more software applications for storage in a memory device of the peripheral device.

15. The system of claim 9 wherein the near field communication signal includes instructions soliciting the peripheral device to transmit a second near field communication signal to the near field communication interface.

16. The system of claim 9 wherein the control circuitry includes a programmable processor and executable control software stored on a non-transitory computer readable medium, and wherein the executable control software is executed during transmission of the near field communication signal.

17. A method comprising:
a near field configuration device transmitting a near field communication signal to a peripheral device;
powering at least a portion of the peripheral device via power in the near field communication signal; and
configuring at least the portion of the peripheral device via configuration data, information, or instructions in the near field communication signal.

18. The method of claim 17 further comprising powering the portion of the peripheral device via the near field communication signal while the peripheral device is inside of a packaging carton.

19. The method of claim 17 further comprising the peripheral device displaying an indicator of configuration status viewable while the peripheral device is inside of a packaging carton.

20. The method of claim 17 further comprising storing configuration data received in the near field communication signal in a memory device of the peripheral device.
